(19) United States
(12) Patent Application Publication
(10) Pub. No.: US 2015/0150744 A1
(43) Pub. Date: Jun. 4, 2015

(54) LOWER LEG PROTECTOR

(71) Applicant: Osborn Medical Corp., Utica, MN (US)

(72) Inventors: Keith C. Ware, Burnsville, MN (US); William D. Davis, Denver, CO (US)

(21) Appl. No.: 14/558,309

(22) Filed: Dec. 2, 2014

Related U.S. Application Data
(60) Provisional application No. 61/910,702, filed on Dec. 2, 2013.

(51) Int. Cl. A61G 13/12

(52) U.S. Cl. CPC A61G 13/1245

(57) ABSTRACT

A lower leg protector includes a body having a base and a recessed region. The recessed region is arranged in the body opposite the base and is configured to receive a lower leg of a patient. The lower leg protector operates to protect the lower leg of a patient during a medical procedure

### CROSS REFERENCE TO RELATED APPLICATION

This application claims priority to U.S. Application Ser. No. 61/910,702, filed on Dec. 2, 2013, entitled LOWER LEG PROTECTOR, the disclosure of which is hereby incorporated by reference in its entirety.

### BACKGROUND

During certain medical procedures a patient is required to lie relatively motionless on a supporting surface. Pressure points arise when the patient's body makes contact with the supporting surface or other relatively hard objects. When the pressure applied to the skin at a pressure point is sufficiently large, the blood flow to the skin or underlying tissue can be obstructed. If the pressure remains for an extended time, the skin or muscle cells at that point can begin to die, leading to a localized injury in the skin or underlying tissue. Infections may also develop at the location of the injury.

### SUMMARY

In general terms, this disclosure is directed to a lower leg protector. In one possible configuration, and by non-limiting example, the lower leg protector is configured to protect a lower leg of a patient during a medical procedure.

One aspect is a lower leg protector comprising: an elongated body having a top, a bottom, a proximal end, and a distal end; a base arranged along the bottom to support the body on a support surface; and a recessed region providing an opening in the top and the proximal end of the body, the recessed region being configured to receive and support a lower leg of a person, the recessed region comprising: a calf support portion configured to support at least a part of a calf muscle region of the lower leg; an Achilles tendon support portion configured to support an Achilles tendon region of the lower leg; and a cavity portion configured to receive a heel region of the lower leg.

Another aspect is a lower leg protector comprising: a base; a left support portion connected to and extending outwardly from the base; a right support portion connected to and extending outwardly from base opposite the left support portion; the left and right support portions being configured to flex apart to receive a lower leg of a patient; a front support portion connected to and located between the left and right support portions and adjacent the base; the lower leg protector having a raised portion configured to support the lower leg of the patient to at least slightly elevate a heel of the patient to reduce pressure on the patient's heel when the patient is lying on the patient's back, wherein the lower leg protector defines a cavity for protecting the heel of the patient.

A further aspect is a method of using a lower leg protector, the method comprising: arranging the lower leg protector on a support surface, the lower leg protector including a body having a base and a recessed region arranged opposite the base; positioning a lower leg of a patient in the lower leg protector; supporting and protecting the lower leg during a medical procedure; and removing the lower leg from the lower leg protector.

### BRIEF DESCRIPTION OF THE DRAWINGS

FIG. 1 is a perspective view of a patient lying on a supporting structure during a medical procedure, and further illustrating an example pair of lower leg protectors in accordance with the principles of the present disclosure.

FIG. 2 is a left side perspective view of an example of the lower leg protector shown in FIG. 1.

FIG. 3 is a right side perspective view of the lower leg protector shown in FIG. 2.

FIG. 4 is a bottom plan view of the lower leg protector shown in FIG. 2.

FIG. 5 is a bottom right perspective view of the lower leg protector shown in FIG. 2.

FIG. 6 is a left side perspective view of the lower leg protector shown in FIG. 2.

FIG. 7 is a left side view of the lower leg protector shown in FIG. 2.

FIG. 8 is a top view of the lower leg protector shown in FIG. 2.

FIG. 9 is a front view of the lower leg protector shown in FIG. 2.

FIG. 10 is a rear view of the lower leg protector shown in FIG. 2.

FIG. 11 is a right side perspective view of the lower leg protector shown in FIG. 2.

FIG. 12 is a cross-sectional view of the lower leg protector shown in FIG. 8 taken along line 12-12.

FIG. 13 is the same cross-sectional view of the lower leg protector shown in FIG. 12, and further illustrating the arrangement of a lower leg in the lower leg protector.

FIG. 14 is a left side perspective view of the lower leg protector shown in FIG. 2.

FIG. 15 is a flow chart illustrating an example method of using a lower leg protector during a medical procedure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

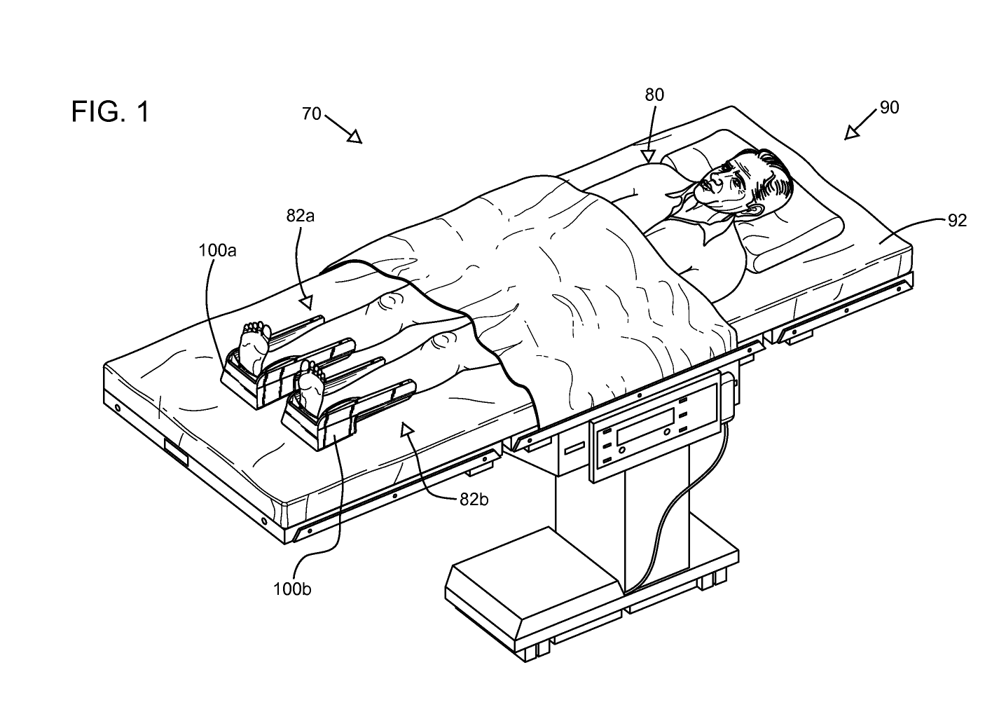

FIG. 1 is a perspective view of an example medical station 70. In this example, the medical station includes a supporting structure 90 having a support surface 92, which is configured to support a patient 80 during a medical procedure. In this example the medical station 70 also includes a pair of lower leg protectors 100 (including lower leg protector 100a and 100b).

One example of a support structure 90 is an operating table. In some embodiments the support structure 90 has a hard upper support surface 92, such as made of stainless steel. Other support surfaces 92 are formed of other materials. The support surface 92 typically includes one or more flat or substantially flat surfaces on which a portion of the patient's body rests, including the lower legs 82 (including lower legs 82a and 82b) of the patient 80.

Lower leg protectors 100 are provided to protect the lower legs 82 of the patient 80 during a medical procedure. The lower legs 82 include at least the feet and a portion of the leg of the patient 80 below the patient's knees. In some embodiments, the lower leg protectors 100 function to protect the lower legs of the patient from injury. As shown the lower leg protectors 100 are positioned on top of the support surface 92 and between the support surface 92 and the patient's lower legs 82.

In some embodiments the lower leg protectors 100 function to reduce or eliminate pressure points, by providing a cushion between the lower legs 82 and the support surface 92, and by distributing the weight of the lower legs 82 across a larger portion of the lower legs 82. For example, without the lower leg protectors 100, the weight of the lower legs would typically be focused on a small portion of the foot, such as on the heel and/or the ankle The lower leg protectors 100 slightly elevate the lower legs 82 to reduce or remove that pressure and distribute the weight across larger portions of the lower legs 82, such as along the Achilles tendon and calf regions of the legs.

In some embodiments the lower leg protectors 100 function to maintain the feet in a preferred position to protect the feet and lower legs from injury. For example, in some embodiments the feet are held in an upright or generally upright position, such as shown in FIG. 1.

When the lower legs 82 are supported by the lower leg protectors 100, the patient can remain relatively motionless for an extended duration, such as during a medical procedure, without injury to the lower legs 82. An example of a medical procedure is a surgical procedure.

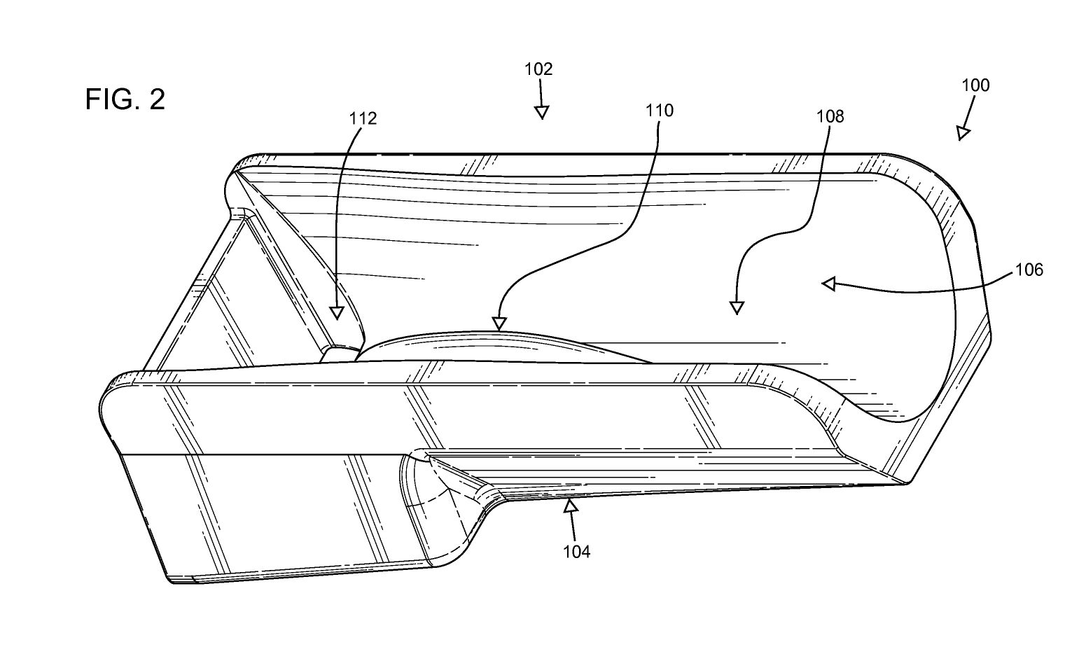

FIG. 2 is a left side perspective view of an example of the lower leg protector 100. In some embodiments the lower leg protector 100 includes a body 102. In this example the body 102 includes a base 104 and a recessed region 106.

In one example, the lower leg protector 100 has an elongated body 102 arranged and configured to support the lower leg of the patient 80 when the patient 80 is lying down. In some embodiments the body 102 is made of a cushioning material, such as polyurethane foam.

The body 102 typically includes a base 104 extending along the bottom. The base 104 typically includes a flat or substantially flat surface configured to be placed on the support surface 92, and to support the body 102 on the support surface 92 in the orientation shown in FIG. 1.

The body 102 also includes a recessed region 106 arranged opposite the base and accessible through the top side of the body 102, and also through at least a proximal end (relative to the patient 80) of the body 102. The recessed region 106 is configured to receive and support the lower leg 82 of the patient 80 therein. In some embodiments a lateral cross-section of at least portions of the body 102 along the recessed region 106 is generally U-shaped, such as illustrated and described in further detail with reference to FIG. 10.

During a medical procedure the lower legs 82 are held in body by the force of gravity, and therefore the lower leg protector 100 is typically free of additional straps, fabric, or other enclosures or restraints, although other embodiments could be made including such features, if desired.

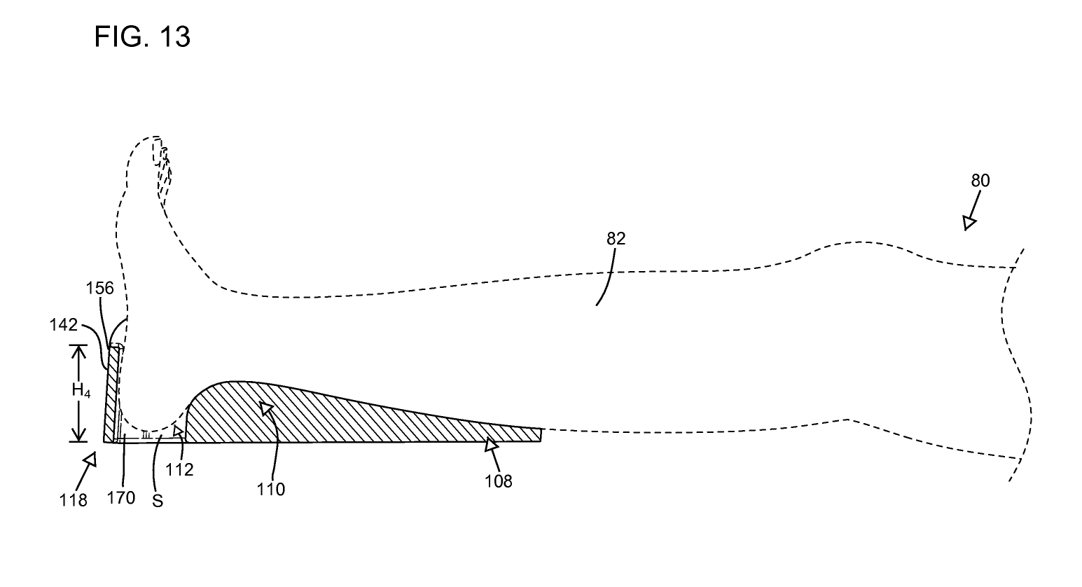

In some embodiments the recessed region 106 of the body 102 includes a calf support portion 108, an Achilles tendon support portion 110, and a cavity portion 112. A cross-sectional view of the body 102 is illustrated and described with reference to FIG. 13, which shows an exemplary shape of the recessed region 106 in further detail.

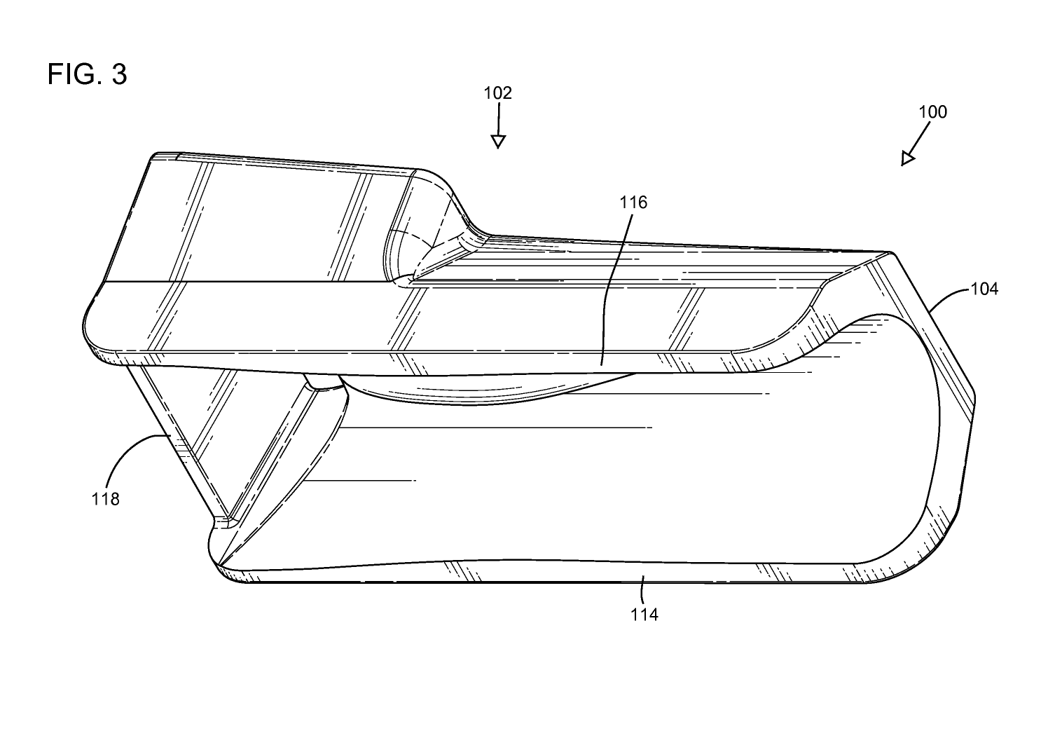

FIG. 3 is a right side perspective view of the example lower leg protector 100. In this example, the elongated body 102 of the lower leg protector 100 includes a left support portion 114, a right support structure 116, and a front support portion 118.

In some embodiments the body 102 of the lower leg protector 100 is integrally formed of one piece connecting the base 104, left and right support portions 114 and 116, and the front support portion 118 together.

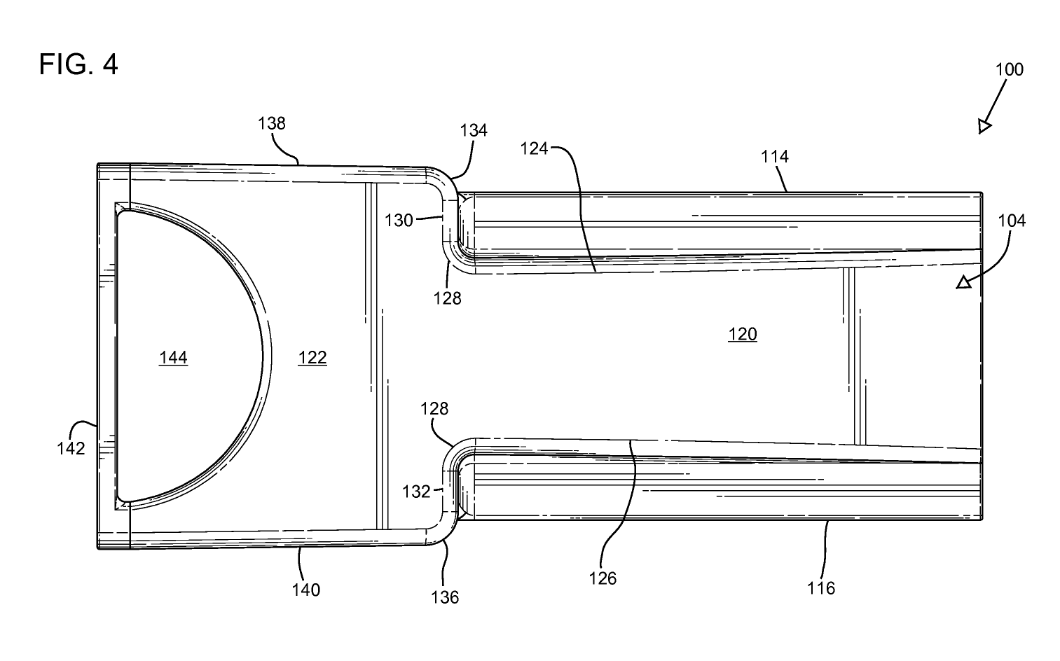

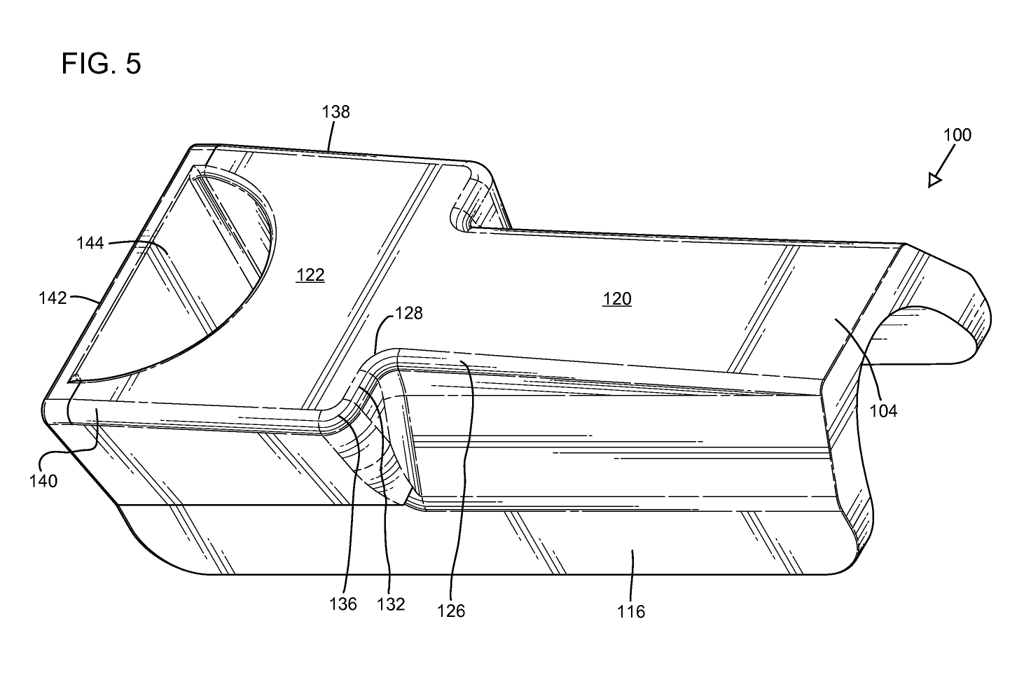

The base 104 typically supports a back portion of the lower leg of a patient 80, such as along the Achilles tendon and at least a portion of the calf. The base 104 helps protect against injuries, such as pressure sores. The base 104 is illustrated and described in more detail with reference to FIGS. 4-5.

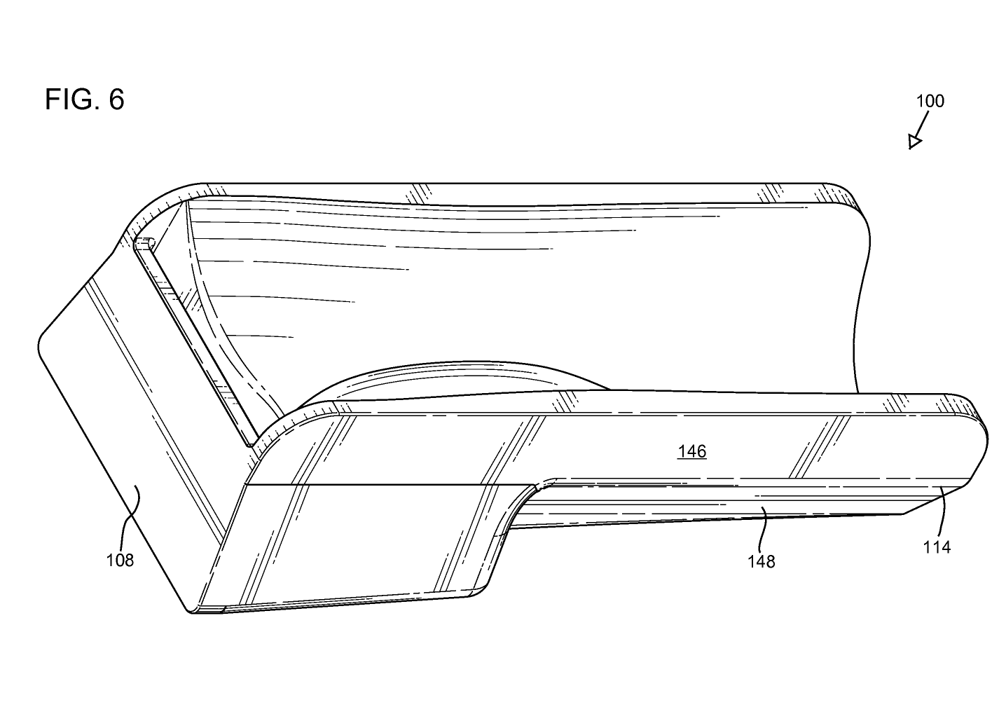

The left support portion 114 of the lower leg protector 100 extends adjacent to the base 104 and supports portions of the lower leg. The left support portion 114 helps keep the foot in an upright position, while also reducing or eliminating pressure on the heel. In some embodiments, the left support portion 114 may be integrally formed with or coupled to the base 104 to provide one continuous piece. The left support portion 114 is illustrated and described in more detail with reference to FIGS. 6-8.

The right support portion 116 of the lower leg protector 100 extends adjacent to the base 104 in a direction opposite to the left support portion 114. Similar to the left support portion 114, the right support portion 116 helps to keep the foot in an upright position, while also reducing or eliminating pressure on the heel. In some embodiments, the right support portion 116 can be integrally formed with or coupled to the base 104 to form one continuous piece. In some embodiments the left and right sides of the body 102 are symmetrical such that aspects and features described for the right support structure 116 are also present and applicable to the left support portion 114 shown in FIGS. 6-8.

The front support portion 118 of the lower leg protector 100 can be connected together with the base 104, the left support portion 114, and the right support portion 116. In one example, the front support portion 118, the base 104, the left support portion 114, and the right support portion 116 can be integrally connected or coupled together to form one continuous piece. The front support portion 118 can help to ensure proper positioning of the foot of the patient in the lower leg protector 100, by proving an end wall that the lower leg 82 cannot extend through. As such, the lower leg protector 100 is arranged in the same position during each use.

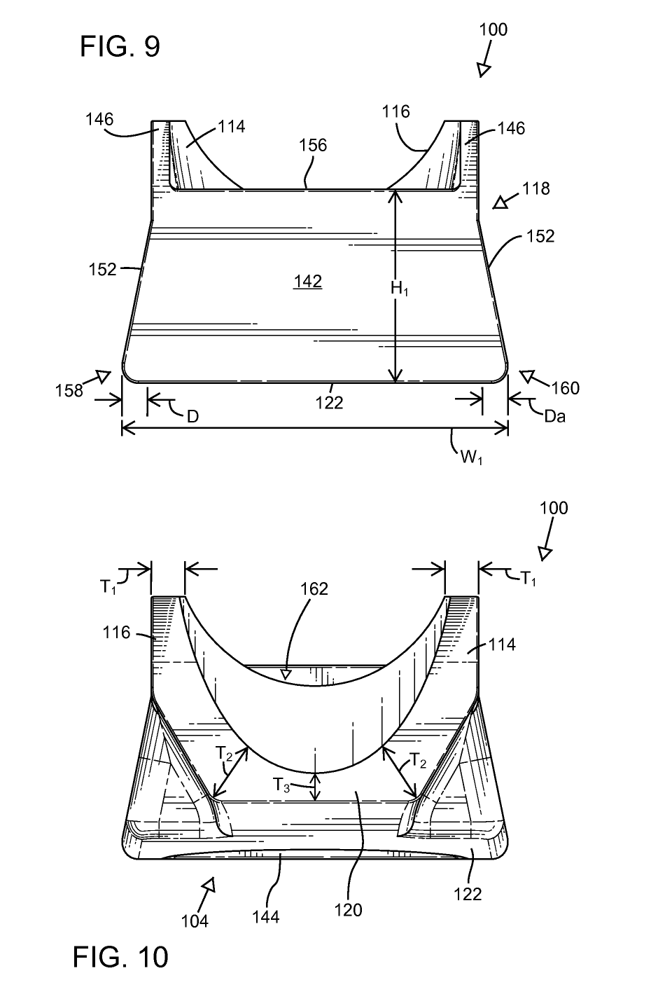

The front support portion 118 also supports the left and right support portions 114 and 116, to help to keep the foot upright if the foot leans over toward the left or right sides. In this way the front support portion 118 helps to prevent the foot from rotating outward to the left or right. The front support portion 118 is illustrated and described in more detail with reference to FIG. 9.

FIGS. 4-5 illustrate features of the base 104.

FIG. 4 is a bottom view of the base 104. In this example, the base 104 is a planar or substantially planar surface that includes a proximal portion 120 and a distal portion 122.

In some embodiments the base 104 is formed of a cushioning material. The body 102 can be constructed of a variety of materials including elastomers (e.g., rubber), polyurethane foam, and/or other open and/or closed cell foams or combinations thereof, for example. The durometer and resilience of the material preferably permits the material to compress slightly under the weight of the lower leg 82 and returns to its original shape when the lower leg 82 is removed. In some embodiments, the body 102 is formed of polyurethane foam having a hardness rating from about 42 to about 52. In other embodiments, the polyurethane foam has a hardness rating of or about 47. In some embodiments the entire lower leg protector 100 is formed of the same single material. In some embodiments the hardness rating involves the durometer A scale, such as measured according to an ASTM standard of ASTM International. One example of an ASTM standard is the ASTM D2240 type A scale.

In some embodiments the lower leg protector 100 is formed of a molded material. An example of a molded material is polyurethane foam. A more specific example is a cold cure high resilient molded foam. One suitable example of such a foam is the Moleculon® cold cure high resilient molded foam. Another example is a memory foam material.

In other embodiments the lower leg protector 100 is formed from another material or combination of materials. As one example, another embodiment of the lower leg protector 100 is formed of a fabric exterior casing and stuffed with a filler material, such as a fiber material (e.g., polyester, cotton, down, or other fiber materials such as used in upholstery, pillows, or other padded objects), or other filler materials (e.g., bean fillers, bead fillers, Styrofoam balls, and the like).

In some embodiments the proximal portion 120 of the base 104 includes a left side 124 and a right side 126 opposite the left side 124 that define the side boundaries of the proximal portion 120. Recessed regions are formed adjacent the left and right sides 124 and 126. The recessed regions reduce the amount of material required for the body 102 and also reduce the overall weight. Additionally, the recessed regions also provide a unique ornamental appearance to the body 102.

The proximal portion 120 joins the distal portion 122 at one end. In some embodiments the ends of the left and right sides 124 and 126 join with the distal portion 122 at corners 128. Because the distal portion 122 does not include the side recesses, horizontal members 130 and 132 are formed adjacent the corners 128, providing the bottom surface of the distal portion 122 with an increased width. The increased width provides greater stability and reduces the chance that the body 102 will tip over.

In some embodiments, the distal portion 122 includes a left shoulder 134 and a right shoulder 136 that each extend from the horizontal members 130 and 132 respectively.

Extending adjacent to the left and right shoulders 134 and 136 in the longitudinal direction are left and right walls 138 and 140. An end wall 142 extends between the left and right walls 138 and 140 forming an end of the distal portion 122.

In some embodiments the distal portion 122 includes a cutout region 144. The cutout region 144 is positioned to permit the lowermost edge of the patient's heel to extend at least partially into the cutout region 144. This cutout region 144 permits the heel to be positioned in close proximity to the support surface 92, and may even allow the heel to contact the support surface 92, while reducing the weight placed on the heel to reduce or prevent injuries. An advantage of the cutout region is that it allows the lower leg 82 to be supported very close to the table, rather than requiring the heel to be spaced from the table by the thickness of the material of the distal portion 122. If the heel were instead elevated, the elevation could cause a backwards bend in the knee, resulting in strain to the knee. The cutout region 144 prevents this by allowing the heel to extend to, or nearly to, the support surface, reducing unnecessary strain on the knee. In some embodiments the cutout region 144 has a semi-circular shape, or semi-elliptical, while other embodiments have other configurations. In some embodiments the cutout region 144 includes a straight edge adjacent to the end wall 142, and an opposite arcuate edge.

FIG. 5 is a bottom right perspective view of the lower leg protector 100. Illustrated in FIG. 5 are the base 104 including the proximal portion 120 and the distal portion 122, the right side 116, the end wall 142, and the cutout region 144. Additional corners and edges are also shown, as discussed in further detail herein.

FIG. 6 is a left side perspective view of the lower leg protector 100. In this example the left support portion 114 is shown.

The left support portion 114 of the elongated body 102 of the lower leg protector 100 includes an elongated member 146 and a tapered portion 148. In some embodiments the elongated member 146 is integrally formed with the tapered portion 148 to form one continuous piece. In other embodiments the elongated member 146 is a separate piece fastened to the tapered portion 148. The elongated member 146 extends along a longitudinal side of the lower leg protector 100 towards the front support portion 118. In one example, interior and exterior surfaces of the tapered portion 148 taper inwardly from the elongated member 146 toward the base 104 (see FIG. 5). The interior surface of the tapered portion 148 provides a gradual curved shape that corresponds to the typical shape of a lower leg 82 to provide support to the lower leg 82 of the patient 80, such as at and around the sides of the calf muscle region of the lower leg 82.

In some embodiments the exterior surface of the tapered portion 148 also tapers inward toward the base 104, forming a recessed region adjacent to the base 104. As discussed herein, the recessed region reduces the amount of material needed to make the lower leg support portion, decreases cost, and provides for a unique ornamental appearance.

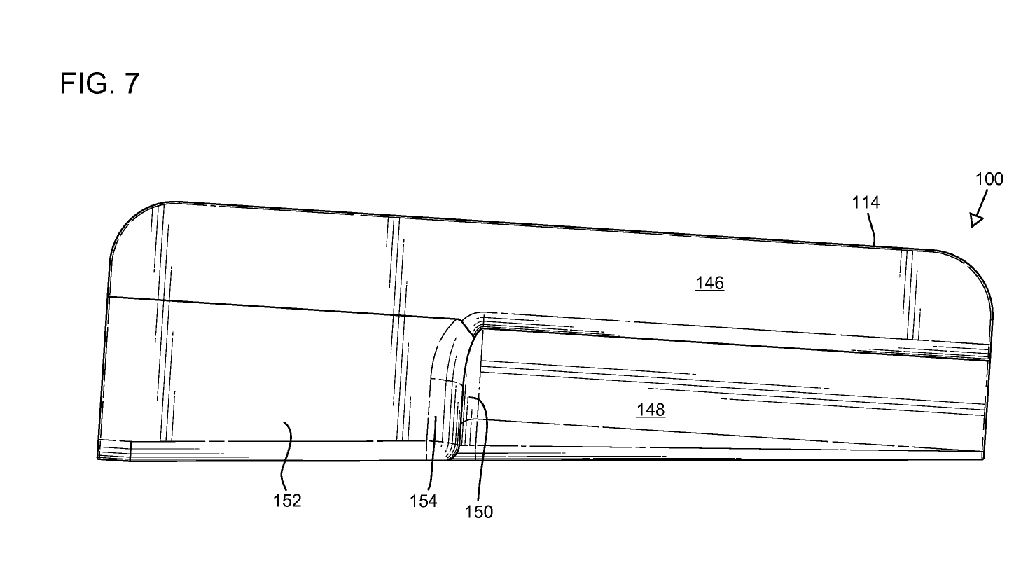

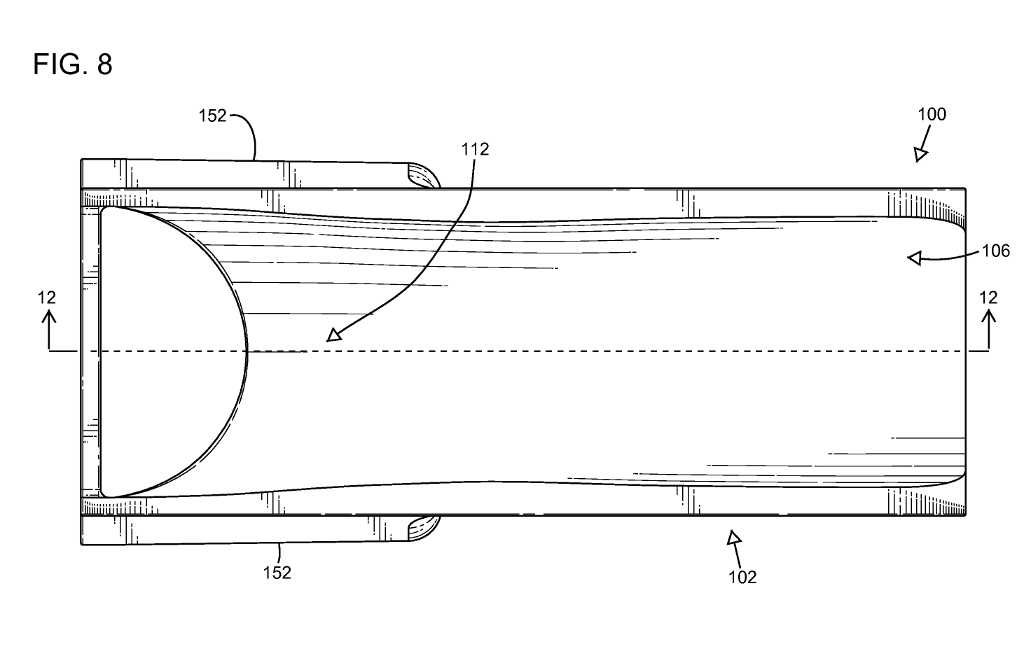

FIGS. 7-8 illustrate additional views of the lower leg protector 100. FIG. 7 is a left side view of the lower leg protector 100, and FIG. 8 is a top view.

The left support portion 114 defines a recess 150 between the tapered portion 148 and a panel 152 of the left support portion 114. The panel 152 includes a top surface 154 that forms a rounded corner and engages or connects to the recess 150. The panel 152 is configured to form the boundary of the cavity portion 112 of the recessed region 106.

In some embodiments the panels 152 flare outward toward the distal portion 122 of the base 104. This shape expands the surface area and width of the distal portion 122, providing increased frictional contact with the support surface 92 as well as increased stability to counteract rotational forces applied by the lower leg that may otherwise cause the lower leg protector 100 to tip over on its side.

Many of the features of the right support portion 116 are similar to the left support portion 114 shown in FIGS. 6-8. Accordingly, some of the features of the left support portion 114 are not separately repeated herein for the right support portion 116. In some embodiments the right support portion 116 is a mirror image of the left support portion 114.

FIG. 9 is a front view of the lower leg protector 100, and illustrates an example of the front support portion 118. The front support portion 118 includes an end wall 142. The front support portion 118 also includes and terminates at an upper surface 156, ends of the left and right panels 152, and the distal portion 122 of the base 104.

The front support portion 118 connects together and supports the left and right panels 152 with the base 104 to maintain the desired position and orientation. The end wall 142 also forms a closed end of the lower leg protector 100, such that the recessed region 106 (FIG. 2) does not extend through the front support portion 118. This end wall 142 aides a user in the proper positioning and orientation of the lower leg protector 100 on the lower leg 82 of the patient 80, because the lower leg 82 cannot extend through the end wall 142.

The end wall 142 is typically formed of a cushioning material, such as the polyurethane foam described herein. The end wall 142 has some degree of flexibility, so that if the bottom of the patient's foot comes in contact with the end wall 142, the end wall will flex. This allows the end wall 142 to gently support the bottom of the patient's foot while distributing any contact forces evenly through the contacting surface of the foot, reducing the chance of injury at this point of contact. It is also possible that no contact will be made between the bottom of the patient's foot and the end wall 142.

In certain examples, the front support portion 118 can be arranged and configured such that the panels 152 flare outwardly from the elongated members 146. The distance or amount of flare between the elongated members 146 and the panels 152 is defined as D, Da. The flared configuration of the front support portion 118 and base 104 helps to provide stability and keep the foot positioned upright. The front support portion 118 helps to prevent the foot of the patient 80 from rotating, which could otherwise cause the hip to twist resulting in potential injury.

In one example, the flared configuration of the front support portion 118 has a width W₁. In some embodiments the W₁ is in a range from about 3 inches to about 10 inches. In other embodiments the width W₁ is in a range from about 4 inches to about 8 inches. In other embodiments, the width W₁ is in a range from about 5 inches to about 7 inches.

FIG. 10 is a rear view of an example of the lower leg protector 100.

In some embodiments the lower leg protector 100 provides a longitudinal channel 162 that receives the lower leg of the patient 80. In order to match the typical shape of the lower leg 82 of a patient, the thickness of the lower leg protector 100 varies to permit the surface of the channel 162 to mimic the shape of the lower leg, including the shape of the calf muscles and the ankle region, including the Achilles tendon regions. In one example, the thicknesses of the left and right support portions 114 and 116 and the base 104 vary between a first thickness T₁ at the sides of the lower leg, to a second thickness T₂ at corners between the sides and the base, and to a third thickness T₃ along the middle of the proximal portion 120 of the base 104. In some embodiments the thicknesses T₁, T₂, and T₃ vary along the longitudinal length of the lower leg protector 100. For example, the thickness T₃ is shown in FIG. 13 as it varies from a reduced thickness below the calf, to an increased thickness in the region of the Achilles tendon. In some examples, the thickness T₃ is configured to support the lower leg 82 in a position that reduces the downward pressure on the knee, as discussed in further detail herein. In some embodiments a patient 80 may wear two of the lower leg protectors 100, as shown in FIG. 1. As a result, it is desired that the thickness of the left and right support portions 114 and 116 are kept thin enough to permit the adjacent lower leg protectors to support the lower legs 82 relatively close to each other, so that the legs do not need to be excessively spread apart. On the other hand, the thickness of the left and right support portions 114 and 116 is also selected such that the material has sufficient strength to provide adequate support to the lower legs to keep the lower legs 82 within the recessed region 106.

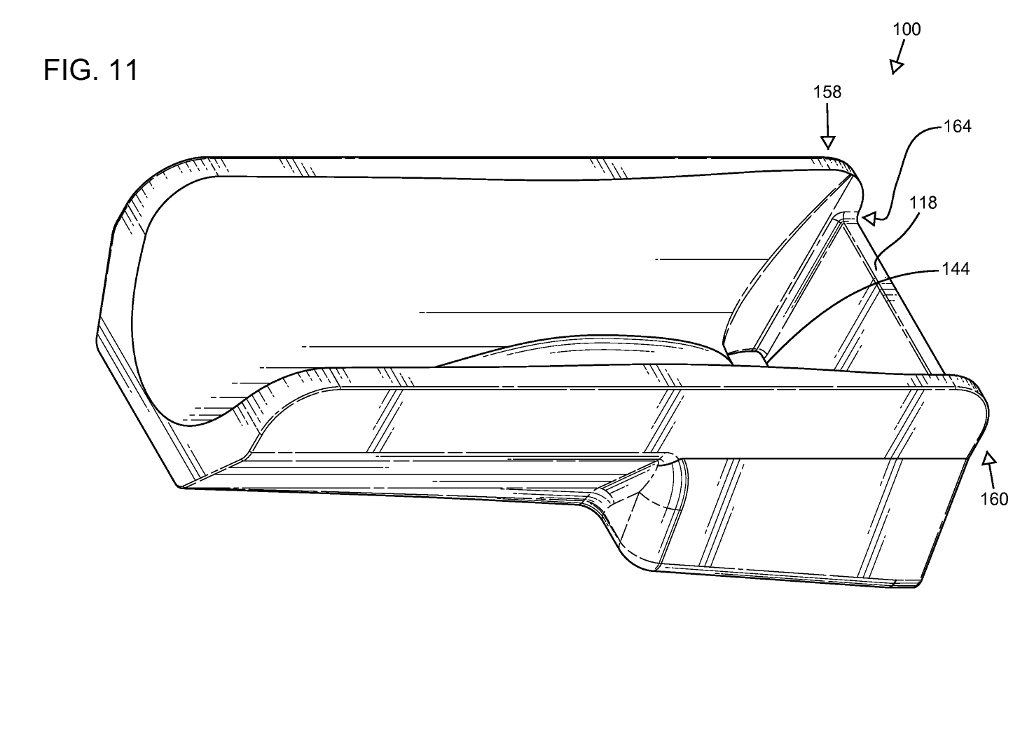

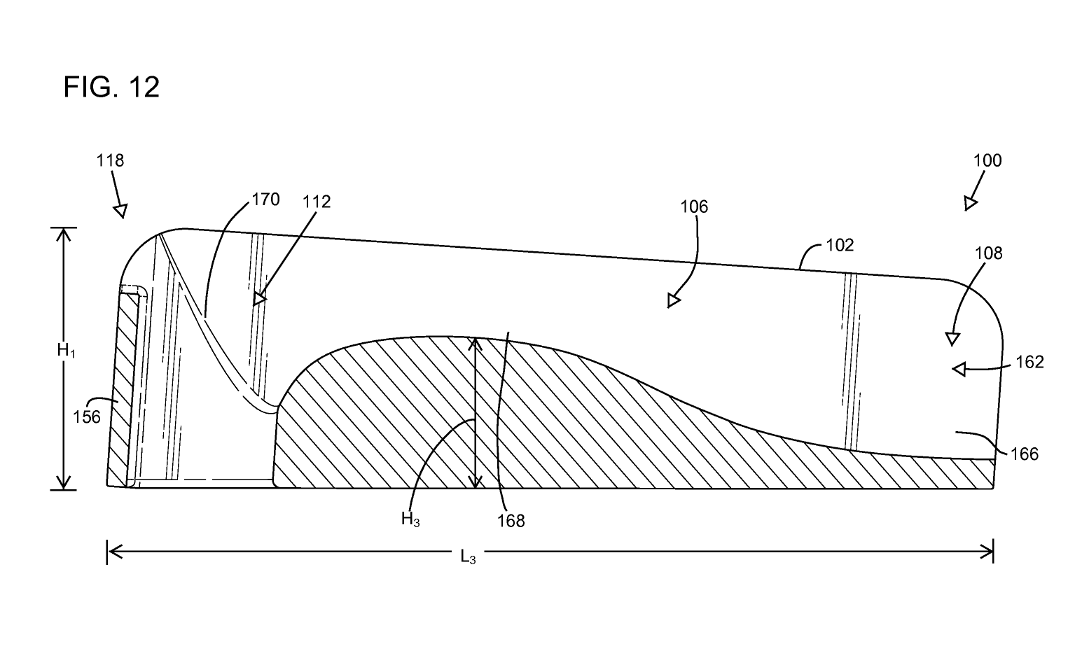

FIG. 11 is a right side perspective view of an example of the lower leg protector 100, illustrating additional details of the front support portion 118. In some embodiments the front support portion 118 defines a notch 164 between the left and right sides 158, 160. In one example, the notch 164 provides access to the lower leg adjacent the bottom of the foot of the patient for routing hoses or tubing within the lower leg protector 100. The left and right sides 158 and 160 form side supports to hold the hoses or tubing within the notch 164 to prevent them from sliding out. As one example, the notch 164 supports tubing or hoses coupled to a compression therapy device, such as to provide increased blood flow in the lower leg 82. In another possible embodiment, the hoses or tubing can also or alternatively be routed through the cutout region 144 (see FIG. 4).

FIGS. 12 and 13 are cross-sectional views of the lower leg protector 100. FIG. 12 is a cross-sectional view of the lower leg protector 100 shown in FIG. 8 taken along line 12-12. FIG. 13 is the same cross-sectional view but further illustrating the arrangement of a lower leg 82 in the lower leg protector 100.

In some embodiments, the body 102 includes a longitudinal channel 162 that forms a recessed region 106 for receiving and supporting the lower leg 82 of the person. In some embodiments the longitudinal channel 162 includes a proximal surface 166, an elevated surface 168, and a cavity portion 112. The proximal surface 166 corresponds to the calf support portion 108 of the recessed region 106, and the elevated surface 168 corresponds to the Achilles tendon support portion 110 of the recessed region 106.

In some embodiments the proximal surface 166 is contoured and has a curved shape to mimic the typical shape of the calf of the lower leg 82. The contoured surface helps to distribute and equalize support on the lower leg or calf and prevents pressure points that might induce skin ulcerations or abrasion.

In some embodiments, the elevated surface 168 of the proximal surface 166 is arranged and configured to support the Achilles tendon region of the patient 80. In one example, the elevated surface 168 has a height H₃ measured from the bottom surface of the base 104. In some embodiments the maximum height H₃ of the elevated surface 168 is in a range from about 0.3 inches to about 4 inches, and preferably less than about 3 inches or less than about 2 inches. The elevated surface 168 is shaped to elevate and support the lower leg in the Achilles tendon area, and in doing so causes the heel to be elevated from the support surface, or at least reduces weight and pressure on the heel.

In one example, the lower leg protector 100 has an overall length L₃. In some embodiments the length L₃ is selected to span a distance from a bottom of a patient's foot to at least a portion of the patient's calf. Typically the lower leg protector 100 is configured so that it does not extend up to or beyond the patient's knee, although other embodiments could be configured to do so. The length L₃ is typically in a range from about 6 inches to about 18 inches. In some embodiments the length L₃ is in a range from about 8 inches to about 14 inches. In other embodiments the length L₃ is in a range from about 9 inches to about 12 inches.

In certain examples, a height H₂ of the body 102 of the lower leg protector 100 decreases from the front support portion 118 toward the calf support portion 108, to reduce unnecessary material and provide a unique ornamental appearance. In other embodiments the height H₂ is uniform along the length of the body 102.

Referring to FIG. 13, the lower leg protector 100 is shown with the leg of the patient 80 positioned within the recessed region 106.

In one example, the calf support portion 108, the Achilles tendon support portion 110, and the cavity portion 112 of the recessed region 106 (see FIG. 2) help to distribute weight evenly along the lower leg 82 and to support the lower leg 82. Additionally, in some embodiments the lower leg protector 100 is configured to avoid downward pressure on the knee (e.g., tending to cause the knee to bend backward), which may otherwise occur if the foot of the patient was significantly elevated from the support surface 92. In some embodiments the lower leg protector 100 is arranged and configured such that the lower leg is supported close to the support surface 92.

The cavity portion 112 provides a cavity in which the heel is allowed to float or gently rest. Additionally, sides of the cavity portion 112 support the foot in an upright position so that the toes point generally upward and the foot is positioned upright at approximately 90 degrees to the rest of the lower leg. This arrangement of the foot also helps to protect the soft tissues within the lower leg, such as tendons, ligaments, and muscles, from strain that may occur if the foot is allowed to point downward or lean over onto the left or the right side for an extended period of time.

In one example, an open space S is provided such that the bottom of the heel is free from any contact along the base 104 of the elongated body 102 of the lower leg protector 100. In other examples, the bottom of the heel extends into the cutout region 144 (see FIG. 5) of the distal portion 122 (see FIG. 5). Although the heel may contact the supporting structure 90 through the cutout region 144, pressure on the heel is reduced because at least a majority of the weight is distributed by the recessed region 106 (see FIG. 2) to other parts of the lower leg.

In certain examples, the lower leg protector 100 stabilizes the foot against flexing and rotation when the patient 80 rests in a supine position and the lower leg protector 100 is supported on the support surface 92.

In some embodiments the lower leg protector 100 is sized as a one-size-fits-most product. The flexibility of the lower leg protector 100 material permits the sides and end to flex to accommodate lower legs that are wider or longer than a typical sized adult person. More specifically, if the lower leg protector 100 is used on a larger patient, the left support portion 114 and the right support portion 116 (see FIG. 3) can be constructed to flare out away from each other to better position the leg therein. In other words, the left and right support portions 114, 116 can be configured to flex apart to receive the lower leg of the patient 80.

It would also be possible to have multiple different sizes, or even custom sizes, but this would require some users (e.g., a hospital) to maintain an inventory of the multiple different sizes. A single product that works for most if not all patients is preferred.

In one example, the end wall 142 of the front support portion 118 has a height H₄ that is constructed to be a sufficient distance to help support and the foot and sides of the ankle while the foot is in an upright position. In some embodiments the height H4 is less than the overall height H2, shown in FIG. 12, to form the notch 164 shown in FIG. 11. The end wall 142 is configured to bend and stretch to avoid the formation of additional pressure points on the bottom of the foot of the patient 80.

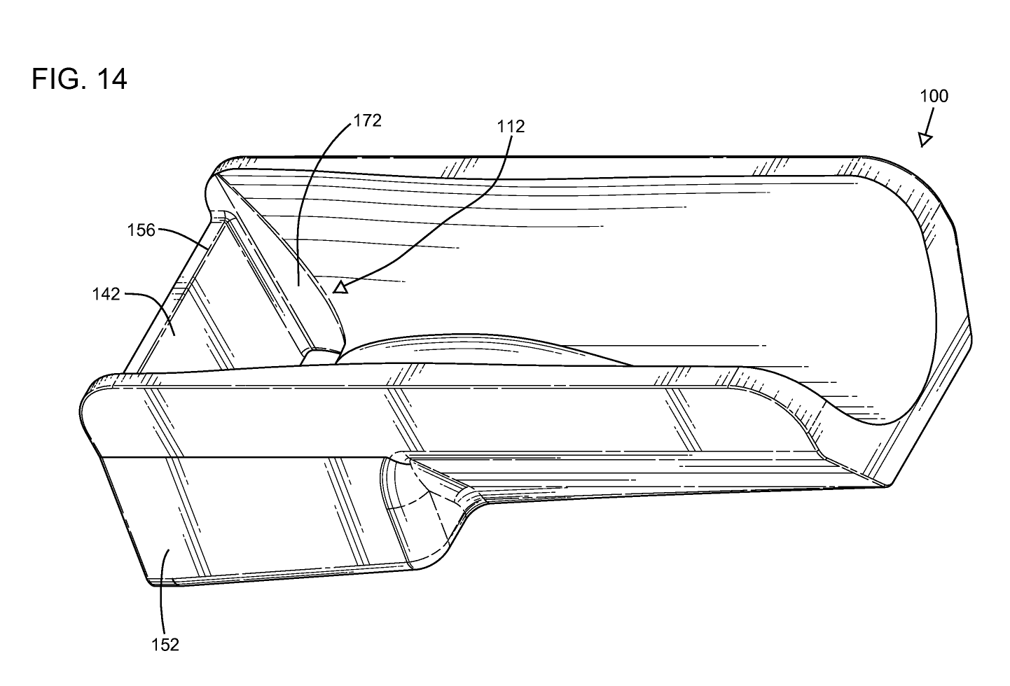

FIG. 14 is a left side perspective view of the lower leg protector 100. As shown, the lower leg protector 100 includes a cavity portion 112. In some embodiments the cavity portion 112 is partially defined by pockets 172. The pockets 172 are shaped to protect the heel of the patient in the cavity portion, with only gentle and distributed contact being made with the heel. The geometry and configuration of the panels 152 and pockets 172 may vary in other embodiments. In other examples, the pockets 172 can have a rounded bottom integrally formed at the front support portion 118 along the perimeter thereof. The size, geometry, and configuration of the rounded bottom may vary in other embodiments.

In some embodiments the lower leg protector 100 is a relatively dense elastic material that flexes or compresses to provide a resilient interface with the lower leg, for example, foam.

In some embodiments, the lower leg protector 100 has a blue, green, and or bluish-green color. Such a color matches similar colors often worn by doctors and nurses during medical procedures, and is selected to have a calming effect. For example, the lower leg protector 100 can be bluish-green in color based on a Pantone Matching Systems (PMS) chart.

In other examples, the lower leg protector 100 can for example be constructed of a variety of materials including elastomers, polyurethane foam, and/or other open and/or closed cell foams or combinations thereof. The durometer and resilience of the material preferably compresses slightly and springs back to shape upon relieving any pressure.

In certain examples, the lower leg protector 100 may be reusable. In situations where the lower leg protector 100 is not contaminated during wear, the lower leg protector 100 may be used again. In some embodiments the lower leg protector 100 is washable or sanitizable. In other examples, the lower leg protector 100 may be disposable. During an operation, blood or other fluids may contact the lower leg protector 100, and therefore a low cost disposable lower leg protector 100 may be desirable.

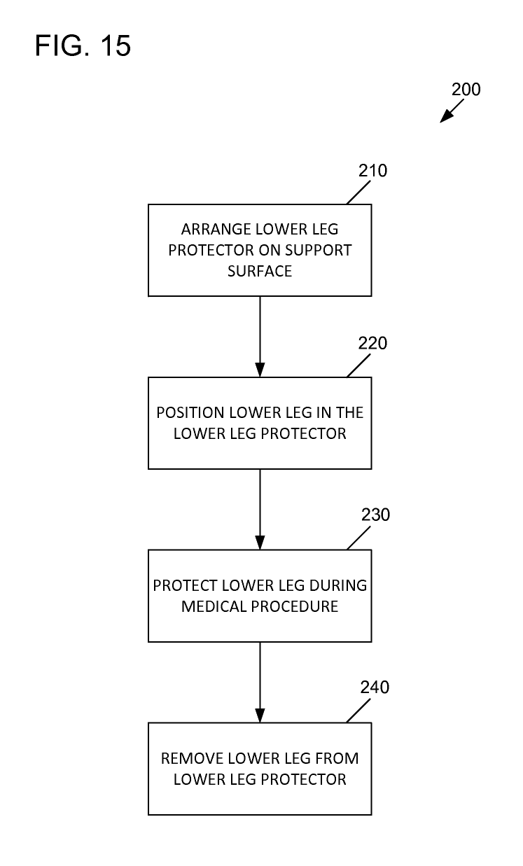

FIG. 15 is a flow chart illustrating an example method 200 of using a lower leg protector 100. In this example, the method 200 includes operations 210, 220, 230, and 240.

The operation 210 is performed to arrange the lower leg protector 100 on a support surface 92 of a supporting structure 90 (such as illustrated in FIG. 1). An example of the supporting structure 90 is an operating table. Other embodiments include other support structures.

The operation 220 is performed to position a lower leg 82 of a patient in the lower leg protector 100. For example, the lower leg 82 is elevated from the support surface and arranged directly over the lower leg protector 100. The lower leg 82 is then lowered through the open top of the lower leg protector and into the recessed region 106 where it comes into contact with the longitudinal channel 162.

During the operation 220, the user can utilize the end wall 142 to assist in proper positioning of the lower leg. For example, because the end wall 142 forms a closed end, the user is guided to orient the end wall away from the patient. Additionally, the end wall 142 provides a stop that guides the user to arrange the patient's foot adjacent the end wall. Accordingly, in some embodiments, during operation 220 the user determines the appropriate orientation of the lower leg protector 100, and arranges the lower leg into the recessed region 106 such that the bottom of the patients foot is touching or adjacent to the end wall 142.

The operation 230 involves supporting and protecting the lower leg of the patient during the medical procedure. In some embodiments the operation 230 includes distributing a weight of the lower leg evenly across portions of the lower leg to eliminate or reduce pressure points. In some embodiments the operation 230 involves elevating or offloading weight from a heel of the lower leg. Additionally, in some embodiments the operation 230 involves supporting the foot of the person in an upright position.

The medical procedure may be performed on any part of the body, and the lower leg protector 100 operates to protect the lower leg 82 during the medical procedure. Examples of the medical procedures include surgical procedures, medical examinations, laboratory or diagnostic procedures (e.g., a CAT scan or MRI), and medical therapies.

After the medical procedure has concluded, operation 240 is performed to remove the lower leg 82 from the lower leg protector 100. In some embodiments the operation 240 involves lifting the lower leg of the patient out from the open top of the lower leg protector. In some embodiments the lower leg protector 100 is removed from the support surface 92. In other embodiments the lower leg is set down on the support surface 92 adjacent the lower leg protector.

In another possible embodiment, the operation 240 involves grasping the lower leg protector 100 and sliding it away from the patient's body until it comes out from under the lower leg, without separately lifting the lower leg 82.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A lower leg protector comprising:
an elongated body having a top, a bottom, a proximal end, and a distal end;
a base arranged along the bottom to support the body on a support surface; and
a recessed region providing an opening in the top and the proximal end of the body, the recessed region being configured to receive and support a lower leg of a person, the recessed region comprising:
a calf support portion configured to support at least a part of a calf muscle region of the lower leg;
an Achilles tendon support portion configured to support an Achilles tendon region of the lower leg; and
a cavity portion configured to receive a heel region of the lower leg.

2. The lower leg protector according to claim 1, wherein the elongated body comprises a left support portion connected to and extending from the base; a right support portion connected to and extending from the base opposite the left support portion; and a front support portion connected to and located between the left and right support portions.

3. The lower leg protector according to claim 1, wherein the recessed region is configured to distribute weight along the lower leg of the patient to reduce pressure on the patient's heel.

4. The lower leg protector according to claim 1, wherein the cavity portion defines a cavity wherein the heel of the patient can be suspended with a space therein.

5. The lower leg protector according to claim 1, wherein the base of the lower leg protector includes a proximal portion and a distal portion.

6. The lower leg protector of claim 5, wherein the distal portion includes a cutout region extending from the cavity portion and through the base.

7. The lower leg protector according to claim 1, wherein the lower leg protector has a length configured to support the lower leg up to at least about ⅓ of the length of the calf-muscle region.

8. The lower leg protector according to claim 2, wherein the left and right support portions are constructed with a polymer material that allows the left and right support portions to flex.

9. The lower leg protector according to claim 5, wherein the distal portion of the base has rounded corners.

10. The lower leg protector according to claim 1, wherein the elongated body, the base, and the recessed region are integrated as a single piece.

11. A lower leg protector comprising:
a base;
a left support portion connected to and extending outwardly from the base;
a right support portion connected to and extending outwardly from base opposite the left support portion; the left and right support portions being configured to flex apart to receive a lower leg of a patient; and
a front support portion connected to and located between the left and right support portions and adjacent the base;
the lower leg protector having a raised portion configured to support the lower leg of the patient to at least slightly elevate a heel of the patient to reduce pressure on the patient's heel when the patient is lying on the patient's back, wherein the lower leg protector defines a cavity for protecting the heel of the patient.

12. The lower leg protector according to claim 11, wherein the base comprises:
an proximal portion, the proximal portion of the base includes a left side and a right side opposite the left side, wherein the left and right sides define an outside perimeter of the proximal portion; and
a distal portion, the distal portion including shoulders configured to extend past the left and right sides of the proximal portion.

13. The lower leg protector according to claim 11, the left and right support portions each comprising:
an elongated member being configured to extend along a longitudinal side of the lower leg protector;
an angled portion facing inwardly from the elongated member toward the base;
panels positioned below the angled portions and adjacent to the elongated member; and
a recess formed between the angled portions and the panels of the lower leg protector.

14. The lower leg protector according to claim 13, wherein the panels each define a pocket configured to curve outwardly therefrom and adjacent to the front support portion to provide space for the ankle of the patient.

15. The lower leg protector according to claim 11, wherein the lower leg protector is constructed of polyurethane foam.

16. The lower leg protector of claim 15, wherein the polyurethane foam has a durometer in a range from 42 to 52.

17. The lower leg protector according to claim 11, wherein the front support portion defines a notch for routing tubing out a front of the lower leg protector.

18. The lower leg protector according to claim 11, further comprising an interior region being defined by the base, the left support portion, the right support portion, and the front support portion.

19. A method of using a lower leg protector, the method comprising:
arranging the lower leg protector on a support surface, the lower leg protector including a body having a base and a recessed region arranged opposite the base;
positioning a lower leg of a patient in the lower leg protector;
supporting and protecting the lower leg during a medical procedure; and
removing the lower leg from the lower leg protector.
